(19) United States
(12) Patent Application Publication
(10) Pub. No.: US 2012/0097138 A1
(43) Pub. Date: Apr. 26, 2012

(54) ENGINE ASSEMBLY INCLUDING ROTARY ENGINE PROVIDING EXHAUST GAS RECIRCULATION TO PRIMARY ENGINE

(75) Inventor: EDWARD J. KEATING, ORTONVILLE, MI (US)

(73) Assignee: GM GLOBAL TECHNOLOGY OPERATIONS, INC., DETROIT, MI (US)

(21) Appl. No.: 12/908,272

(22) Filed: Oct. 20, 2010

(51) Int. Cl. F02M 25/07

(52) U.S. Cl. 123/568.11

(57) ABSTRACT

An engine assembly may include a rotary engine and a reciprocating engine. The rotary engine may include a first engine structure defining a rotor housing, a rotor located within the rotor housing and cooperating with the first engine structure to define a first combustion chamber and a first exhaust port defined by the first engine structure and in communication with the first combustion chamber. The reciprocating engine may include a second engine structure defining a cylinder bore and a piston disposed within the cylinder bore and cooperating with the second engine structure to define a second combustion chamber in communication with the first exhaust port.

### FIELD

The present disclosure relates to engine assemblies including exhaust gas recirculation systems.

### BACKGROUND

This section provides background information related to the present disclosure which is not necessarily prior art.

Internal combustion engines may combust a mixture of air and fuel in cylinders and thereby produce drive torque. Combustion of the air-fuel mixture produces exhaust gases. Engines may include an exhaust gas recirculation system to return a portion of the exhaust gas to the engine for a subsequent combustion event.

### SUMMARY

An engine assembly may include a rotary engine and a reciprocating engine. The rotary engine may include a first engine structure defining a rotor housing, a rotor located within the rotor housing and cooperating with the first engine structure to define a first combustion chamber and a first exhaust port defined by the first engine structure and in communication with the first combustion chamber. The reciprocating engine may include a second engine structure defining a cylinder bore and a piston disposed within the cylinder bore and cooperating with the second engine structure to define a second combustion chamber in communication with the first exhaust port.

The engine assembly may additionally include a first intake manifold and a crankshaft. The crankshaft may be rotationally driven by the rotor and the piston. The first intake manifold may be in communication with the first exhaust port and the second combustion chamber. The first intake manifold may provide an exhaust gas from the rotary engine to the second combustion chamber. The first engine structure may be located at a longitudinal end of the second engine structure.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a perspective view of the engine assembly of FIG. 1;

FIG. 3 is a section view of the engine assembly of FIG. 1; and

FIG. 4 is a perspective view of an alternate engine assembly according to the present disclosure.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

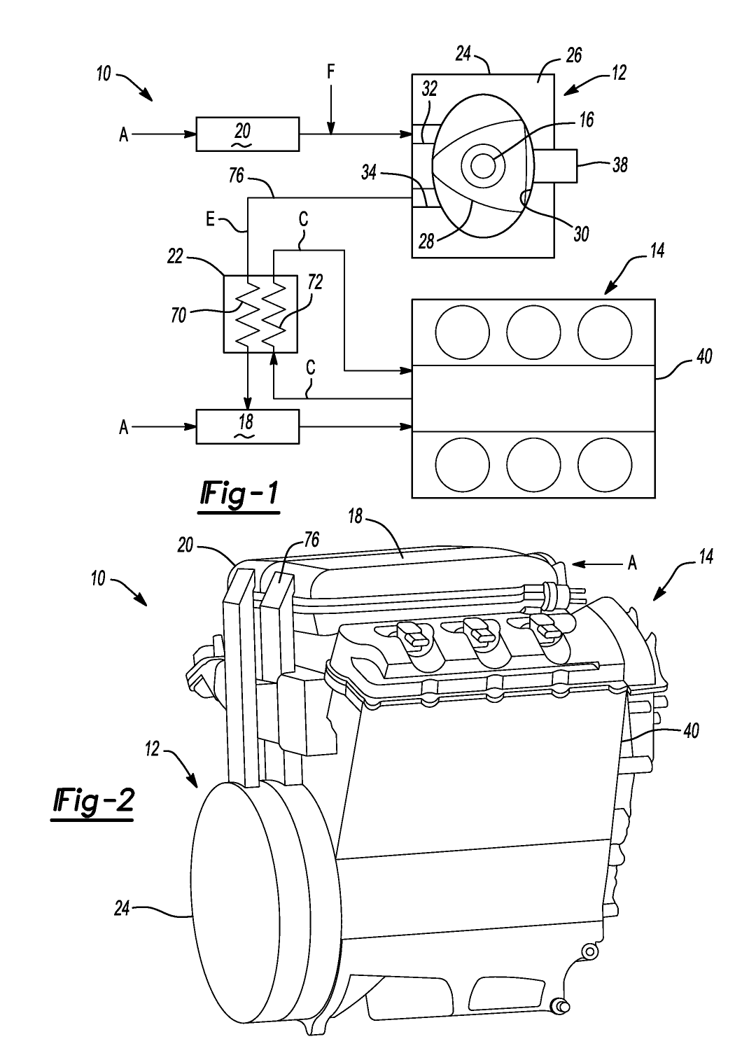

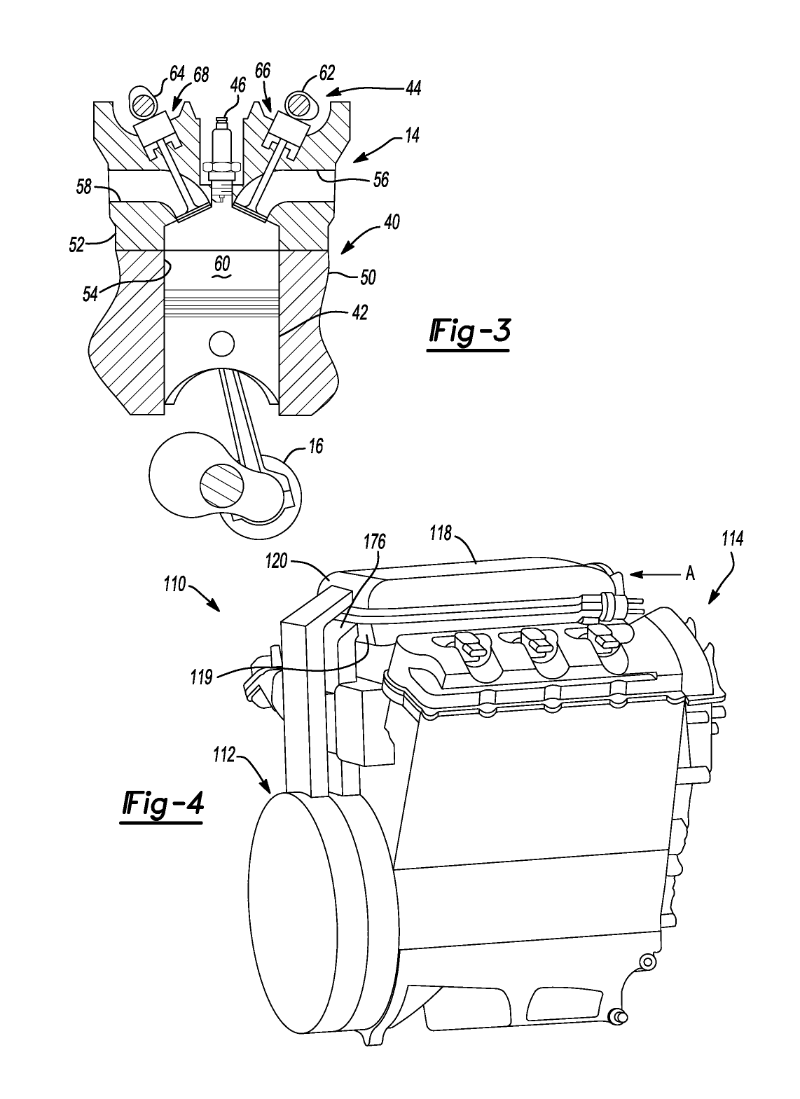

An engine assembly 10 is illustrated in FIGS. 1-3 and may include a rotary engine 12, a reciprocating engine 14, a crankshaft 16 rotationally driven by the rotary engine 12 and the reciprocating engine 14, a first intake manifold 18, a second intake manifold 20 and a heat exchanger 22. The rotary engine 12 may be coupled to the reciprocating engine 14 and may be a Wankel engine. The reciprocating engine 14 may form a primary engine, providing a majority of the drive torque for rotation of the crankshaft 16 and the rotary engine 12 may form a secondary engine.

The rotary engine 12 may include a first engine structure 24 defining a rotor housing 26, a rotor 28 located in the rotor housing 26 and cooperating with the first engine structure 24 to define a first combustion chamber 30, a first intake port 32 in communication with the first combustion chamber 30, a first exhaust port 34 in communication with the first combustion chamber 30 and an ignition mechanism 38. By way of non-limiting example, the ignition mechanism 38 may include one or two spark plugs in communication with the first combustion chamber 30.

The reciprocating engine 14 may include a second engine structure 40, a piston 42, a valvetrain assembly 44, a spark plug 46, and a fuel injector (not shown). The second engine structure 40 may include an engine block 50 and a cylinder head 52. The second engine structure 40 may define a cylinder bore 54 in the engine block 50 and a second intake port 56 and a second exhaust port 58 in the cylinder head 52. A single cylinder of the reciprocating engine 14 is described for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

The piston 42 may be disposed in the cylinder bore 54 and may cooperate with the second engine structure 40 to define a second combustion chamber 60. The second intake port 56 and the second exhaust port 58 may be in communication with the second combustion chamber 60. The valvetrain assembly 44 may be supported by the second engine structure 40 on the cylinder head 52 and may include intake and exhaust camshafts 62, 64 and intake and exhaust valve assemblies 66, 68. The intake camshaft 62 may be engaged with the intake valve assembly 66 and the exhaust camshaft 64 may be engaged with the exhaust valve assembly 68.

The first intake manifold 18 may be in communication with a fresh air source (A) and the second combustion chamber 60 via the second intake port 56. The second combustion chamber 60 may be in communication with the first exhaust port 34 of the rotary engine 12. In the present non-limiting example, the first exhaust port 34 of the rotary engine 12 may be in communication with the first intake manifold 18. The first exhaust port 34 may therefore be in communication with the second intake port 56 via the first intake manifold 18 to provide exhaust gas (E) from the rotary engine 12 to the second combustion chamber 60 of the reciprocating engine 14.

The second intake manifold 20 may be in communication with a fresh air source (A) and the first combustion chamber 30 via the first intake port 32. The first combustion chamber 30 may additionally be in communication with a fuel source (F) and the air-fuel mixture may be combusted within the first combustion chamber 30 to drive the rotor 28.

The heat exchanger 22 may define a first passage 70 in communication with the exhaust gas (E) from the rotary engine 12 and a second passage 72 in communication with an engine coolant (C). In the present non-limiting example, the second passage 72 may be in communication with liquid engine coolant (C) from the reciprocating engine 14. However, it is understood that the second passage 72 may alternatively receive engine coolant from the rotary engine 12 or from a combination of the rotary engine 12 and the reciprocating engine 14. In the present non-limiting example, the heat exchanger 22 may form an exhaust gas cooler located on the second engine structure 40. The heat exchanger 22 may be located in the flow path of the exhaust gas (E) at a location between the first exhaust port 34 and the second intake port 56.

The rotary engine 12 may be located on a longitudinal end of the reciprocating engine 14. More specifically, the first engine structure 24 may be fixed to the second engine structure 40 at the longitudinal end of the reciprocating engine 14. The first engine structure 24 may define an exhaust gas conduit 76 forming an exhaust gas passage extending from the first exhaust port 34 to the first intake manifold 18. Therefore, all of the exhaust gas generated by the rotary engine 12 may be provided to the first intake manifold 18. The rotor 28 and the piston 42 may each be engaged with the crankshaft 16 and the crankshaft 16 may be rotationally driven by both the rotor 28 and the piston 42. In the present non-limiting example, the rotor 28 may be located on a longitudinal end of the crankshaft 16.

The combination of the rotary engine 12 with the reciprocating engine 14 may provide a controlled amount of exhaust gas recirculation (EGR) to the reciprocating engine 14. Additionally, using the rotary engine to provide EGR to the reciprocating engine 14 may allow all of the exhaust gas exiting the reciprocating engine 14 to proceed to the exhaust system (not shown) of the reciprocating engine 14, improving catalyst warm-up.

While the engine assembly 10 is described as including first and second intake manifolds 18, 20, it is understood that alternate arrangements may include a single intake manifold 118 as seen in the engine assembly 110 of FIG. 4. The engine assembly 110 may be generally similar to the engine assembly 10, with the exceptions indicated below.

In the example shown in FIG. 4, the intake manifold 118 may be in communication with a fresh air source (A) and both the rotary engine 112 and the reciprocating engine 114. The exhaust gas conduit 176 of the rotary engine 112 may be in communication with a first region 119 of the intake manifold 118 and the first intake port (not shown) of the rotary engine 112 may be in communication with a second region 120 of the intake manifold 118 to prevent recirculation of the exhaust gas from the rotary engine 112 to the first intake port of the rotary engine 112.

What is claimed is:

1. An engine assembly comprising:
a rotary engine including:
a first engine structure defining a rotor housing;
a rotor located within the rotor housing and cooperating with the first engine structure to define a first combustion chamber; and
a first exhaust port defined by the first engine structure and in communication with the first combustion chamber; and
a reciprocating engine including:
a second engine structure defining a cylinder bore; and
a piston disposed within the cylinder bore and cooperating with the second engine structure to define a second combustion chamber in communication with the first exhaust port.

2. The engine assembly of claim 1, further comprising a first intake manifold in communication with a fresh air source, the first exhaust port, and the second combustion chamber, the first exhaust port being in communication with the second combustion chamber via the first intake manifold and providing an exhaust gas from the rotary engine to the second combustion chamber.

3. The engine assembly of claim 2, further comprising a second intake manifold, the first engine structure defining a first intake port in communication with the first combustion chamber and the second intake manifold.

4. The engine assembly of claim 3, wherein the second engine structure defines a second intake port in communication with the first intake manifold.

5. The engine assembly of claim 2, wherein the first engine structure includes an exhaust gas conduit extending from the first exhaust port to the first intake manifold.

6. The engine assembly of claim 1, further comprising a crankshaft engaged with and rotationally driven by the rotor and the piston.

7. The engine assembly of claim 6, wherein the rotary engine defines a Wankel engine.

8. The engine assembly of claim 1, wherein the rotary engine is located at a longitudinal end of the reciprocating engine.

9. The engine assembly of claim 8, further comprising an exhaust gas cooler defining a first passage in communication with exhaust gas from the rotary engine.

10. The engine assembly of claim 9, wherein the exhaust gas cooler is located on the second engine structure and defines a second passage in communication with an engine coolant.

11. An engine assembly comprising:
a first intake manifold;
a crankshaft;
a rotary engine including:
a first engine structure defining a rotor housing;
a rotor engaged with the crankshaft, located within the rotor housing and cooperating with the first engine structure to define a first combustion chamber; and
a first exhaust port defined by the first engine structure and in communication with the first combustion chamber and the first intake manifold and providing an exhaust gas from the rotary engine to the first intake manifold; and
a reciprocating engine including:
a second engine structure defining a cylinder bore; and
a piston coupled to the crankshaft, disposed within the cylinder bore and cooperating with the second engine structure to define a second combustion chamber in communication with the first intake manifold.

12. The engine assembly of claim 11, further comprising a second intake manifold, the first engine structure defining a first intake port in communication with the first combustion chamber and the second intake manifold.

13. The engine assembly of claim 12, wherein the second engine structure defines a second intake port in communication with the first intake manifold.

14. The engine assembly of claim 11, wherein the rotary engine defines a Wankel engine.

15. The engine assembly of claim 11, wherein the rotary engine is located at a longitudinal end of the reciprocating engine.

16. The engine assembly of claim 15, further comprising an exhaust gas cooler defining a first passage in communication with exhaust gas from the rotary engine.

17. The engine assembly of claim 11, wherein the exhaust gas cooler is located on the second engine structure and defines a second passage in communication with an engine coolant.

18. The engine assembly of claim 11, wherein the first engine structure includes an exhaust gas conduit extending from the first exhaust port to the first intake manifold.

19. An engine assembly comprising:
a crankshaft;
a rotary engine including:
a first engine structure defining a rotor housing;
a rotor engaged with the crankshaft, located within the rotor housing and cooperating with the first engine structure to define a first combustion chamber; and
a first exhaust port defined by the first engine structure and in communication with the first combustion chamber; and
a reciprocating engine including:
a second engine structure defining a cylinder bore, the first engine structure located at a longitudinal end of the second engine structure; and
a piston coupled to the crankshaft, disposed within the cylinder bore and cooperating with the second engine structure to define a second combustion chamber in communication with the first exhaust port.

20. The engine assembly of claim 19, further comprising a first intake manifold in communication with a fresh air source, the first exhaust port, and the second combustion chamber, the first engine structure including an exhaust gas conduit extending from the first exhaust port to the first intake manifold and providing an exhaust gas from the rotary engine to the second combustion chamber via the first intake manifold.
